(19) United States
(12) Patent Application Publication
(10) Pub. No.: US 2007/0031565 A1
(43) Pub. Date: Feb. 8, 2007

(54) Aerated frozen confections

(76) Inventors: Myriam Schlegel, Fouquenies (FR); Joselio Batista Vieira, York (GB)

Correspondence Address: WINSTON & STRAWN LLP;PATENT DEPARTMENT, 1700 K STREET, N.W., WASHINGTON, DC, 20006, US

(21) Appl. No.: 11/544,797

(22) Filed: Oct. 5, 2006

Related U.S. Application Data
(63) Continuation of application No. PCT/EP05/03156, filed on Mar. 24, 2005.

(30) Foreign Application Priority Data
Apr. 8, 2004 (EP) 04008549.0

(51) Int. Cl. A23G 9/00

(52) U.S. Cl. 426/565

(57) ABSTRACT

Frozen confection preserving its smoothness and exhibiting reduced ice crystal growth after being exposed to heat shock treatment, comprising fat, sweetener, milk solids-not-fat and water, in which a particular emulsifier of a propylene glycol monoester of fatty acid is used. Also, a process for manufacturing such a frozen confection and a method of using the emulsifier for improving production, storage and distribution of aerated frozen confections extending over time, volume and space, in particular by reducing ice crystal growth after heat shock.

### CROSS-REFERENCE TO RELATED APPLICATIONS

This application is a continuation of International application PCT/IB2005/003156 filed Mar. 24, 2005, the entire content of which is expressly incorporated herein by reference thereto.

### FIELD OF THE INVENTION

The present invention relates to the field of aerated frozen confections and in particular to milk-based frozen confections and to a process for preparing such a confection.

### BACKGROUND OF THE INVENTION

Milk-based frozen confections are traditionally made using ingredients such as: fat, milk solids-not-fat, sweeteners, stabilizers, emulsifiers and water. The various ingredients are mixed together, the mixture is then homogenized, pasteurized, cooled, optionally aged at about 2 to 6° C. and deep-frozen with stirring with injection of air in a freezer to provide a degree of overrun of the order of 30 to 150%.

Frozen confections are particularly appreciated for their creamy and smooth characteristics. However, these products, in order to preserve their optimum organoleptic characteristics of smoothness, have to be stored and handled with care. Thus, temperature variations, even small, can be observed during storage, distribution or handling. This is particularly the case when the consumer buys a frozen confectionery, when they do not consume it straight away and when there is a gap between the time the product is taken from the deep-frozen section and when it is placed in the domestic freezer. In such circumstances, substantial or partial thawing of the product may occur before it is refrozen. Such cycles of temperature variation, called heat-shocks are responsible for the growth of ice crystals in the product. A crystallized texture thus results therefrom. This texture and the icy mouth feel accompanied by an impaired appearance of the product compromises or at the very least reduces its overall quality as perceived by the consumer.

Various gums and/or emulsifiers have been used as additives with the aim of improving the stability, the smoothness and the resistance of frozen confections to heat shocks. These may include guar gum, carob or guar seed flour, alginate, carboxymethyl cellulose, xanthan, carrageenan, synthetic or natural emulsifiers. The milk proteins contained in the milk dry extract participate in this stabilization due to their water-binding property.

However, the use of gums has the disadvantage of conferring on the product a texture which is sometimes too firm or gummy.

WO 01/06865 is concerned with a process for the production of aerated frozen confections which are smooth and have resistance to heat shocks, which makes use of a specific ternary blend of emulsifiers and milk solids-not-fat coming predominantly from skim milk.

The problem which the invention proposes to solve consists in providing a formulation for aerated milk-based frozen confections with increased stability during heat shocks without compromising their organoleptic qualities.

### SUMMARY OF THE INVENTION

The present invention consists in an aerated frozen confection, with or without fat and comprising, sweeteners, milk solids-not-fat, water, emulsifier and stabilizer, characterized in that it comprises by weight:

0 to 12% fat, and preferably 2 to 12% fat,

4 to 10% milk solids-not-fat,

50 to 100% of the milk solids-not-fat is of whey origin,

10 to 25% sweeteners,

0 to 0.5% stabilizers,

at least 0.2% propylene glycol monoester of fatty acid as primary emulsifier,

and it has an overrun of 30 to 150% by volume.

The invention also relates to a process for making aerated frozen confections comprising the following steps:

dispersing, heating and homogenizing the ingredients entering into the composition of a frozen confection according to the present invention at a temperature, a pressure and for a period sufficient to hydrate and pasteurize the mixture,

cooling the mixture to a temperature of between 2 and 8° C.,

optionally aging of the mixture at a temperature of between 2 and 6° C., with or without stirring, during a time period of 4 to 24 h,

freezing the mixture to a temperature of between −4° C. and −7° C., with incorporation of gas providing a degree of overrun of between 30 and 150%, and

hardening the mixture by deep-freezing to a temperature of between −20° C. and −40° C.

The invention further relates to a method of improving storage stability of aerated frozen confections, by reducing ice crystal growth after heat shock, by using in such aerated frozen confections a propylene glycol monoester of fatty acid as a primary emulsifier in an amount of at least 0.2% by weight.

The percentages indicated in the description relate to the percentages by weight except in the case of the overrun values which are defined in % by volume.

### DETAILED DESCRIPTION OF THE PREFERRED EMBODIMENTS

Preferably, a frozen confection according to the present invention may comprise 2 to 12% fat, 10 to 25% of sweeteners, 8 to 10% of milk solids-not-fat of which 80 to 100% are of whey origin, 0.1 to 0.5% of stabilizers, at least 0.2% of propylene glycol monoester of fatty acid as primary emulsifier and water as balance.

Thus, according to the invention, the partial or total replacement of the milk solids-not-fat from milk and skim milk powder traditionally used by milk proteins from sweet whey at a level of 50% by weight or more allows substantial savings while maintaining or improving the resistance to heat shocks. Furthermore, the product thus obtained has a creamy and smooth mouth feel close to or even superior to that of the traditional product containing skim milk solids and mono-di glycerides as emulsifier. Thus, apart from the mere economic advantage, the invention makes it possible to simultaneously improve the textural and organoleptic qualities of frozen confections, in particular after heat shock abuses.

The milk solids-not-fat used for making a frozen confection according to the invention may be powdered or concentrated defatted sweet whey, for example. They may include powdered or concentrated skim milk, for example. Milk solids-not-fat may also be derived from a commercial mixture of milk powder and whey proteins whose functionality has been modified by specific denaturation treatments.

Preferably, propylene glycol monoester of fatty acid is used as a primary emulsifier in an amount of 0.2 to 0.5% and most preferably in an amount of at least 0.26%. Preferably propylene glycol monostearate/palmitate is used.

The frozen confections according to the invention may optionally comprise one additional emulsifier, for example, unsaturated monoglyceride or saturated mono-di glyceride in an amount of at least 5% of the total emulsifiers, preferably in an amount of 0.04 to 0.16% by weight as partial replacement of propylene glycol monoester of fatty acid.

The frozen confections according to the present invention may comprise stabilizing agents; these may include carob flour, guar flour, alginates, carboxymethyl cellulose, xanthan, carrageenan, gelatin, starches used alone or in the form of a mixture at a dose of 0.1 to 0.5%, preferably about 0.25%.

The fat used may be a vegetable or animal fat, hydrogenated or otherwise fractionated, for example. It may be a fat of plant origin, preferably palm, coconut, soybean, rapeseed, olive, palm kernel oil, hydrogenated coconut oil, hydrogenated soybean oil, palm olein and their mixtures. It may also be a fat of animal origin, preferably butter fat and/or its fractions.

Particularly preferred is a fat selected from the group consisting of palm oil, coconut oil, hydrogenated coconut oil, palm kernel oil and their mixtures.

The sweetener used may be sucrose, glucose, fructose or glucose syrup with DE (dextrose equivalent) varying from 20 to 42, or a mixture thereof, for example. The formulation of the product according to the invention may in addition comprise colourings such as beta-carotene, for example, and/or any type of flavourings or perfumes customarily used to flavour frozen confections, such as vanilla, strawberry or chocolate for example.

The compositions according to the invention may optionally comprise additions such as fruit or fruit pieces, for example, or nuts, or hazelnuts, whole or in pieces, for example.

The choice of such ingredients makes it possible to obtain products with increased stability as well with a substantial reduction in the cost price. These savings are made through the partial replacement of the milk solids-not-fat traditionally used by whey. Furthermore, the organoleptic qualities of the frozen compositions according to the invention are not reduced compared with the traditional products. Thus, the characteristics of smoothness and creaminess are increased and in particular, better preserved during the period of storage. In the frozen confections according to the invention, it is the use of propylenglycol monoester of fatty acid, as emulsifier which makes it possible to reduce remarkably the growth of water crystals in the products subjected to heat shock and thus it confers greater stability to heat shocks on the product.

For carrying out the process of the invention, the ingredients entering into the composition of a frozen confection according to the present invention may be dispersed at around approximately 60 to 70° C. for approximately 15 to 30 min., for example. The whole may be heated and homogenized at around 70 to 75° C., for example, at a pressure of the order of 140 to 220 bar, for example. These steps of dispersion, heating and homogenisation make it possible to bring about hydration of the stabilizer.

The mixture may then be pasteurized according to methods known to persons skilled in the art, for example at around 80 to 90° C. for 10 to 30 s. The homogenisation-heating step may be carried out at a pasteurization temperature which brings about, on its own, pasteurization of the mixture. The mixture may then be cooled to around 2 to 8° C. by known means. This mixture may then be aged or otherwise for 4 to 24 h at around 2 to 6° C., for example, with or without stirring. After this aging step, the mixture may be frozen at around -3 to -7° C., and preferably at about −4.5 to −6° C. with stirring with injection of gas so as to produce a degree of overrun of the order of 30 to 150%, for example. The mixture obtained may then be hardened by freezing at around −20 to −40° C., for example.

After the aging step, the frozen compositions may, for example, be extruded in the form of bars having a greater or lesser degree of overrun, with the aid of an ice-cream industry refrigerated scraped surface heat exchanger or freezer with injection of gas. The aerated semi-frozen composition coming out of the freezer may also be filled into containers or moulds under pressure using a bottom-up filler, for example.

To evaluate the influence of the partial replacement of milk solids-not-fat from skimmed milk by whey solids and the remarkable properties of the emulsifier applied, various textural, microscopic and macroscopic tests may be carried out.

Standard heat shock: the samples initially stored at −30° C. are subjected, for 7 days, to temperature cycles of −8° C./12 h followed by −20° C./12 h. After 7 days of stabilisation at −30° C., the melting parameters are evaluated for these samples which were subjected to a heat shock.

Size and Distribution of the Ice Crystals in an Ice Confection

An aliquot of ice confection is mixed with an equivalent quantity of glycerol and observed under a microscope at a temperature of −10° C. The measurement may be carried out in a chamber at −10° C. equipped with microscope and a camera. It is thus possible to measure the mean diameter Dm_{(1,0)} of the crystals (in μm) in the finished products and in the products which have been subjected to a heat shock (microscope magnification 10×, respectively 20× according to the size of the crystals).

The frozen confections according to the present invention exhibit improved stability and organoleptic characteristics compared to traditional products. These products exhibit remarkable reduced ice crystal growth compared with traditional products when submitted to heat shock treatment. This property confers to the product smooth texture, which is considerably preserved after unfavourable storage conditions. Such functionalities make it possible to envisage production, storage and distribution of the products according to the invention extending over time.

A frozen confection according to the present invention is therefore characterized in that it preserves its smooth texture and exhibits remarkable reduced growth of ice crystals due to ice recrystallization when submitted to heat shock conditions.

The expression “reduced crystal growth” is understood to mean an increase in the mean diameter of the ice crystals of less than 50% after heat shock (see Tables 2 and 4).

### EXAMPLES

The invention is described below with reference to examples of preferred embodiments and modes of formulation. However, various adaptations and/or modifications may be made while remaining within the scope of the present invention.

### Examples 1 and 2, Comparative Examples 1 to 3

Examples of frozen confections according to the present invention and comparative examples are produced according to the formulations indicated in Table 1 below.

The various ingredients are dispersed at 65° C. and then undergo a hydration step at 60° C. for 20 minutes. The mixture is then homogenized at 180 bar with the aid of homogenizer and then pasteurized at 86° C. for 20 s. After cooling to 5° C., the mixture is aged for 24 hours at 4° C., without stirring. Finally, the mixture is frozen at about −5.1 to −5.7° C. draw temperature with a degree of overrun of 97 to 102%. The ice confection obtained is hardened at −30° C. by conventional means.

TABLE 1

| | | Comp | | Comp | Comp |
|---|---|---|---|---|---|
| Ingredient | Ex. 1 | Ex. 1 | Ex. 2 | Ex. 2 | Ex. 3 |
| Sweet whey powder (SWP) | 10 | 0 | 8 | 0 | 2.5 |
| Skim milk powder (MSK) | 0 | 10 | 2 | 10 | 7.5 |
| PGMS | 0.3 | 0 | 0.3 | 0 | 0.3 |
| UMG | 0.08 | 0 | 0.08 | 0 | 0.05 |
| SMDG | 0 | 0.3 | 0 | 0.3 | 0 |
| Sorbitan tristearate | 0 | 0 | 0 | 0 | 0.03 |
| Guar Gum | 0.25 | 0.25 | 0.067 | 0.067 | 0.15 |
| Kappa carrageenan | 0 | 0 | 0.013 | 0.013 | 0.02 |
| Sodium alginate | 0 | 0 | 0.067 | 0.067 | 0 |
| Carboxymethyl cellulose | 0 | 0 | 0 | 0 | 0.05 |
| Vegetable lauric fat blend | 9 | 9 | 9 | 9 | 10 |
| Sucrose | 14 | 14 | 14 | 14 | 12.5 |
| Glucose syrup DE 38-42 | 3 | 3 | 3.2 | 3.1 | 4.5 |
| Water | 63.37 | 63.45 | 63.35 | 63.37 | 62.4 |

Sweet whey powder: whey proteins, non demineralized from Euroserum, 10 to 12% protein;
Fat: Blend of refined coconut and refined deodorized palm oil;
PGMS: Propylene glycol monostearate PGMS SPV® from Danisco;
UMG: Unsaturated monoglyceride DIMODAN UP/B® from Danisco;
SMDG: Saturated Mono-diglycerides: ADMUL® 60-04 from Quest.

Size of the Crystals and Ice Crystal Growth:

TABLE 2

| | Mean diameter of the ice crystals | | Growth after heat | |
|---|---|---|---|---|
| | Dm (1, 0) (μm) | | shock | |
| | Storage at −30° C. | After heat shock | μm | % |
| Example 1 | 20 | 25 | 5 | 25 |
| Comp. | 31 | 50.5 | 20.5 | 66 |
| Example 1 | | | | |
| Example 2 | 19 | 22.5 | 3.5 | 18 |
| Comp. | 32 | 51 | 19 | 59.5 |
| Example 2 | | | | |
| Comp. | 21 | 26.5 | 5.5 | 26 |
| Example 3 | | | | |

Table 2 shows the mean diameter of the ice crystals in various frozen products. It may be observed that the products containing propylene glycol monoester of fatty acid and UMG and predominantly sweet whey as milk solids-not-fat, on the one hand, a mean crystal diameter smaller than the references after heat shock. The samples according to the invention exhibit increases in crystal size which are significantly less than for the standard products (comparative examples 1 and 2) and even for the product of Example 3 of WO 01/06865 (comparative example 3). Analysis of the size and of the distribution of the ice crystals makes it possible to show that the partial or total replacement of the milk solids-not-fat from skim milk is by milk solids-not-fat from whey improves the stability of the samples subjected to heat shock when propylene glycol monoester of fatty acid is used.
Sensory Analysis:

The samples are evaluated by a panel of people trained in the evaluation of texture. To that end, samples of examples 1 and 2 of the invention are compared with standard ice creams of comparative examples 1 and 2.

The questionnaire distributed contains the descriptive attributes for texture in the mouth:
smoothness, absence of particles, ice crystals in the ice cream mass;
chewyness, resistance to bite and
mouth coating, amount and persistence of the fatty film coating the mouth and palate.

The smoothness of the products of examples 1 and 2 was significantly higher than the comparative examples. Some differences on other attributes were also observed, in particular examples 1 and 2 showed increased chewyness and mouth coating.

### Examples 3-6

Frozen confections are manufactured as in examples 1-2 with different fat levels. As fat a mixture of palm oil and coconut oil is used. The formulations are indicated in Table 3 below. The size and crystal growth after heat shock are indicated in Table 4 below.

TABLE 3

| Ingredient | Ex. 3 | Ex. 4 | Ex. 5 | Ex. 6 |
|---|---|---|---|---|
| Fat | 3.6 | 5.4 | 7.2 | 10.2 |
| Sweet whey powder | 10 | 10 | 10 | 10 |
| PGMS | 0.3 | 0.3 | 0.3 | 0.3 |
| UMG | 0.08 | 0.08 | 0.08 | 0.08 |
| Guar | 0.25 | 0.25 | 0.25 | 0.25 |
| Sucrose | 14 | 14 | 14 | 14 |
| Glucose syrup DE 38-42 | 3 | 3 | 3 | 3 |
| Total solids adjusted to | 36 | 36 | 36 | 36 |
| 36 with glucose syrup DE | | | | |
| 20-22 | | | | |

Size of the Crystals and Ice Crystal Growth:

TABLE 4

| | Mean diameter of the ice crystals | | Growth after heat | |
|---|---|---|---|---|
| | Dm (1, 0) (μm) | | shock | |
| Example | Storage at −30° C. | After heat shock | μm | % |
| 3 | 18.5 | 19 | 0.5 | 2.7 |
| 4 | 19 | 19.5 | 0.5 | 2.6 |
| 5 | 21 | 26.5 | 5.5 | 26 |
| 6 | 21 | 23.5 | 2.5 | 11.9 |

Table 4 shows that the reduction of ice crystal growth after heat shock is substantially independent on the level of fat in the product.

### Example 7

The purpose of this example is to show that the emulsifier PGMS is capable of reducing ice crystal growth after heat shock even when used as sole emulsifier. Thus in this example, the emulsifier PGMS is used alone or together with UMG or SMDG in connection with milk solids-not-fat ingredient. The compositions are given in table 5 below.

TABLE 5

| | | | PGMS/ | | Admul 60.04/ |
|---|---|---|---|---|---|
| Ingredients | Admul 60.04 | PGMS | Admul 60.04 | PGMS/Dimodan UP | Dimodan UP |
| Fat | 9.00 | 9.00 | 9.00 | 9.00 | 9.00 |
| Milk solids-not-fat | 10.00 | 10.00 | 10.00 | 10.00 | 10.00 |
| (SWP 80/MSK 20) | | | | | |
| PGMS | 0 | 0.38 | 0.38 | 0.30 | 0 |
| SMDG | 0.38 | 0 | 0.08 | 0 | 0.30 |
| UMG | 0 | 0 | 0 | 0.08 | 0.08 |
| Stabilizer blend | 0.22 | 0.22 | 0.22 | 0.22 | 0.22 |
| Sugar | 14.00 | 14.00 | 14.00 | 14.00 | 14.00 |
| Glucose syrup | 3.00 | 3.00 | 3.00 | 3.00 | 3.00 |
| DE 40 | | | | | |
| Water to | 100% | 100% | 100% | 100% | 100% |

The results of ice crystal size after heat shock are given in Table 6 below.

TABLE 6

| | Mean diameter of the ice |
|---|---|
| | crystals Dm (1, 0) (μm) |
| | After heat shock |
| Admul 60.04 | 48.5 |
| PGMS | 20.0 |
| PGMS + Admul 60.04 | 20.5 |
| PGMS + Dimodan UP | 19.5 |
| Admul 60.04 + Dimodan UP | 48.0 |

While with the recipes containing conventional mono-diglycerides, the crystal size after heat shock treatment is around 50 μm, all the samples containing PGMS, the ice crystal size was much smaller and around 20 μm.

The heat shock samples were also evaluated by a panel of people which score each attributes in a scale from 0 to 100. The results are given in Table 7 below.

TABLE 7

| | Attribute |
|---|---|
| | Smoothness |
| Admul 60.04 | 24.2 |
| PGMS | 70.8 |
| PGMS + Admul 60.04 | 70.0 |
| PGMS + Dimodan UP | 69.2 |
| Admul 60.04 + Dimodan UP | 35.0 |

The results show that the samples containing PGMS were significantly smoother than those containing only mono-diglycerides.

What is claimed is:

1. Aerated frozen confection, with or without fat and comprising, sweeteners, milk solids-not-fat, water, emulsifier and stabilizer, comprising by weight:
0 to 12% fat,
4 to 10% non-fat milk solids,
50 to 100% of non-fat milk solids of whey origin,
10 to 25% sweeteners,
0 to 0.5% stabilizers,
at least 0.2% propylene glycol monoester of fatty acid as primary emulsifier,
and having an overrun of 30 to 150% by volume.

2. Aerated frozen confection according to claim 1, that includes 2 to 12% fat by weight

3. Aerated frozen confection according to claim 1, wherein the non-fat milk solids are powdered or concentrated defatted sweet whey.

4. Aerated frozen confection according to claim 1, wherein the non-fat milk solids comprise powdered or concentrated skim milk.

5. Aerated frozen confection according to claim 1, wherein the fat is a vegetable or animal fat, hydrogenated or otherwise fractionated.

6. Aerated frozen confection according to claim 5, wherein the fat is selected from the group comprising palm oil, coconut oil, soybean oil, rapeseed oil, olive oil, palm kernel oil, hydrogenated coconut oil, hydrogenated soybean oil, palm olein, fractionated butter fat and their mixtures.

7. Aerated frozen confection according to claim 1, further comprising at least one stabilizer chosen from the group comprising carob flour, guar flour, alginates, carboxymethyl cellulose, xanthan, carrageenan, gelatin, starches used alone or in the form of a mixture at a dose of 0.1 to 0.5%.

8. Aerated frozen confection according to claim 1, wherein the sweeteners are sucrose, glucose, fructose or glucose syrups or a mixture of these agents.

9. Aerated frozen confection according to claim 1, further comprising as an additional emulsifier, an unsaturated monoglyceride or saturated mono-di glyceride in an amount of at least 5% by weight of the total emulsifiers in partial replacement of propylene glycol monoester of fatty acid.

10. Aerated frozen confection according to claim 9, further comprising as additional emulsifier, unsaturated monoglyceride or saturated mono-di glyceride in an amount of 0.04 to 0.16% by weight in partial replacement of propylene glycol monoester of fatty acid.

11. Aerated frozen confection according to claim 1, which has preserved smoothness and exhibits reduced ice crystal growth after being exposed to heat shock conditions.

12. Process for preparing an aerated frozen confection which comprises:
dispersing, heating and homogenizing the following ingredients
0 to 12% fat,
4 to 10% non-fat milk solids,
50 to 100% of non-fat milk solids of whey origin,
10 to 25% sweeteners,
0 to 0.5% stabilizers, and
at least 0.2% propylene glycol monoester of fatty acid as primary emulsifier,
for preparing a composition of a frozen confection at a temperature, a pressure and for a period sufficient to hydrate and pasteurize the mixture,
cooling the mixture to a temperature of between 2 and 8° C.,
optionally aging the mixture at a temperature of between 2 and 6° C., without stirring, during a time period of 4 to 24 h,
freezing to a temperature of between −4° C. and −7° C., while providing a degree of overrun of between 30 and 150%, and
hardening of the mixture by deep-freezing to a temperature of between −20° C. and −40° C.

13. A method of improving production, storage and distribution of aerated frozen confections extending over time, volume and space, by reducing ice crystal growth after heat shock, which comprises using in such aerated frozen confections a propylene glycol monoester of fatty acid as a primary emulsifier in an amount of at least 0.2% by weight.

14. The method according to claim 13, wherein the propylene glycol monoester of fatty acid is present in the aerated frozen confection at an amount of at least 0.26% by weight.

15. The method according to claim 13, wherein the propylene glycol monoester of fatty acid is propylene glycol monostearate/palmitate.

16. The method according to claim 13, which further comprises using as an additional emulsifier, an unsaturated monoglyceride or saturated mono-di glyceride in an amount of at least 5% by weight of the total emulsifiers in partial replacement of propylene glycol monoester of fatty acid.

17. The method according to claim 16, wherein the unsaturated monoglyceride or saturated mono-di glyceride is present in the aerated confection in an amount of 0.04 to 0.16% by weight.
